(19) United States
(12) Patent Application Publication
(10) Pub. No.: US 2012/0107575 A1
(43) Pub. Date: May 3, 2012

(54) TOUCH PANEL HAVING A SEAMLESS OUTER SURFACE AND ITS MANUFACTURING METHOD

(75) Inventor: SHENG-HUNG YI, TAICHUNG CITY (TW)

(73) Assignee: TAIWAN GREEN POINT ENTERPRISES CO., LTD., TAICHUNG CITY (TW)

(21) Appl. No.: 13/282,542

(22) Filed: Oct. 27, 2011

Related U.S. Application Data
(60) Provisional application No. 61/409,654, filed on Nov. 3, 2010.

(51) Int. Cl. B32B 3/00; H01H 11/00

(52) U.S. Cl. 428/195.1; 29/622

(57) ABSTRACT

A touch panel having a seamless outer surface and its manufacturing method are disclosed. The method includes: binding step, placing step, and placing step. Provide a film and a shell. This film has a decorated area and a non-decorated area. Bond this film onto the shell to form an exterior seamless structure. Providing a touch panel and a screen displaying portion, place them together so as to form an internal structure. Finally, place the internal structure into a hollow area of the exterior seamless structure with glue for expelling any air clearance so that the exterior seamless structure and the internal structure are combined as a final product. It has a smooth surface with less shrinkage and is good for decoration. It can reduce thickness significantly. Light transmittance at hollow area is relatively larger. Plus, the sensitivity of the touch panel will perform a better response.

### CROSS-REFERENCE TO RELATED APPLICATION

This application claims the benefit of the filing date of the U.S. Provisional Application No. 61/409,654 filed on Nov. 3, 2010.

### BACKGROUND OF THE INVENTION

1. Field of the Invention

The present invention relates to a touch panel having a seamless outer surface and its manufacturing method. It has a smooth surface with less shrinkage and is good for decoration. It can reduce thickness significantly. Light transmittance at hollow area is relatively larger. Plus, the sensitivity of the touch panel will perform a better response than the traditional touch panel.

2. Description of the Prior Art

Referring to FIGS. 1A and 1B, they show a first traditional mobile phone 80 with touch panel. It is called the recessed design. The first traditional mobile phone mainly includes a recessed casing 81, a first touch panel 82, a first screen displaying portion 83, and other parts (omitted and not shown). The recessed casing 81 contains a recessed portion 84, so the main surface of the first traditional mobile phone 80 is not smooth.

As exhibited in FIGS. 2A and 2B, a second traditional mobile phone 90 with touch panel is disclosed. It is called the step-less design. It includes a casing 91, a second touch panel 92, a second screen displaying portion 93, and other parts (omitted and not shown). Because the outer surface of this casing 91 and the second touch panel 92 are aligned, the entire main surface of the second traditional mobile phone 90 is substantially plat and almost smooth, except the seam 94 (which is a small gap between the casing 91 and the touch panel 92). For some consumers, such seam 94 lowers the touch feeling and makes the appearance not perfect.

In addition, a prior art search is conducted and is described in the following paragraphs.

Concerning the Patent Publication No. TW-200705245 in Taiwan (R.O.C.), on a surface of an upper electrode film of a touch panel, there are a design sheet bonded thereto with a periphery of the design sheet overhung from the touch pane, and a touch panel unit case integrally molded with the design sheet and surrounding side faces of the touch panel with a surface of the case covered with the design sheet.

About the Patent No. TW-M317033 in Taiwan (R.O.C.), an easy-assembling structure of the touch panel assembly is disclosed. It includes a combination frame with electrical chassis, a touch panel having a hollowed portion matching the aforementioned combination frame, and a plaque with a perspective window. In which, a securing lip is disposed on the lower portion of the edges of the combination frame. Multiple locking portions are formed on the upper portion of one edge of this combination frame. On the opposite edge of the combination frame, it is disposed with a connector seat for electrically connecting with the main circuit board. The connector seat is equipped with resilient legs. A signal bus portion is disposed on one side of the touch panel. By embedding the touch panel with the securing lip of the combination frame, the signal bus portion is fixed with the connector seat. Meanwhile, by utilizing the rebounding resilient force generated from the resilient legs as well as the engaging relationship of the locking portions, the touch panel can be embedded in the combination frame. Furthermore, by assembling the plaque on, this plaque can cover the edge between the combination frame and the touch panel. Hence, the touch panel can be easily and quickly disassembled with a small electrical appliance.

With regard to the US Patent Pub. No. US-2009/0135159 A1, it relates to a touch panel assembly. It includes: a transparent front shell adapted to shell a screen of a display and a touch control unit including a transparent multi-layered structure deposited on the transparent front shell. The multi-layered structure defines a plurality of transparent sensor areas, each of which is operable to sense an object when the object touches or closely approaches a location on the transparent front shell that corresponds to the respective one of the sensor areas.

Finally, the U.S. Pat. No. 7,237,937 discloses a touch panel assembly. In which, the thickness of a touch panel is successfully reduced by using a touch panel provided with no reinforcement member. A housing frame that supports the components of a front light unit in an integral manner is provided with a touch panel positioning mechanism, and the touch panel is fixed to the positioning mechanism, whereby the absence of a reinforcement member is duly compensated for, thus ensuring the strength of the touch panel. Deformation of the touch panel that occurs when the touch panel is pressed for operation can be attenuated by a transparent buffer member disposed between the touch panel and a light conductor plate. Therefore, the touch panel deformed is prohibited from contacting and damaging the light conductor plate, thus preventing the light conductor plate from deteriorating in its functional performance. Consequently, reduction in dimension and reduction of the number of components can be achieved without deteriorating the functional performance of the touch panel assembly.

However, these references still have the advantages or problems about not smooth outer surface or ugly seam on the product (such as mobile phone). So, it is necessary to overcome such advantages or problems.

### SUMMARY OF THE INVENTION

The object of the present invention is to provide a touch panel having a seamless outer surface and it manufacturing method. In which, it has a smooth surface with less shrinkage and is good for decoration. It can reduce thickness significantly. Light transmittance at hollow area is relatively larger. Plus, the sensitivity of the touch panel will perform a better response than the traditional touch panel. This invention can solve the advantages and problems in the traditional ones, such as the main surface of the product is not smooth. The seam on the product lowers the touch feeling and makes the appearance not perfect.

In order to achieve above-mentioned object, this invention is provided. In which, a method for manufacturing a touch panel having a seamless outer surface comprising:

bonding step: providing a film having a seamless outer surface and a shell having a hollow area, the film having at least a non-decorated area, the non-decorated area and the hollow area of the shell being substantially overlapped for screen displaying; then bonding the film onto an outer surface of the shell so as to form an exterior seamless structure;

placing step: providing a touch panel and a screen displaying portion, placing the touch panel and the liquid crystal module together so as to form an internal structure; the touch panel being transparent; and

combining step: placing the internal structure into the hollow area of the exterior seamless structure with glue for expelling any air clearance so that the exterior seamless structure and the internal structure being combined as a final product which is an integral structure; the glue being transparent.

In addition, this invention also provides a touch panel having a seamless outer surface comprising:

an exterior seamless structure having a film having a seamless outer surface and a shell having a hollow area, the film having at least a non-decorated area, the non-decorated area and the hollow area of the shell being substantially overlapped for screen displaying; and

an internal structure having a touch panel and a screen displaying portion; the touch panel being transparent; the exterior seamless structure and the internal structure being combined together so as to form as a final product which is an integral structure.

### BRIEF DESCRIPTION OF THE DRAWINGS

FIG. 1A is a perspective view of a first traditional mobile phone.

FIG. 1B is a cross-sectional view taken along the IB-IB lines in FIG. 1A.

FIG. 2A is a perspective view of a second traditional mobile phone.

FIG. 2B is a cross-sectional view taken along the IIB-IIB lines in FIG. 2A.

FIG. 3 is a flow chart of the present invention.

FIG. 4 is a flow chart of another embodiment of the present invention.

FIG. 5A is a perspective view of the film of the present invention.

FIG. 5B is a cross-sectional view taken along the VB-VB lines in FIG. 5A.

FIG. 6A is a perspective view of the shell of the present invention.

FIG. 6B is a cross-sectional view taken along the VIB-VIB lines in FIG. 6A.

FIG. 7A is a perspective view of the exterior seamless structure of the present invention.

FIG. 7B is a cross-sectional view taken along the VIIB-VIIB lines in FIG. 7A.

FIG. 8 is a cross-sectional view showing a structure with the hard-coat layer.

FIG. 9 is a cross-sectional view showing a touch panel.

FIG. 10 is a cross-sectional view showing a screen displaying portion.

FIG. 11 is a cross-sectional view showing a combined the touch panel and the screen displaying portion.

FIG. 12 is a cross-sectional view illustrating the final product of the present invention.

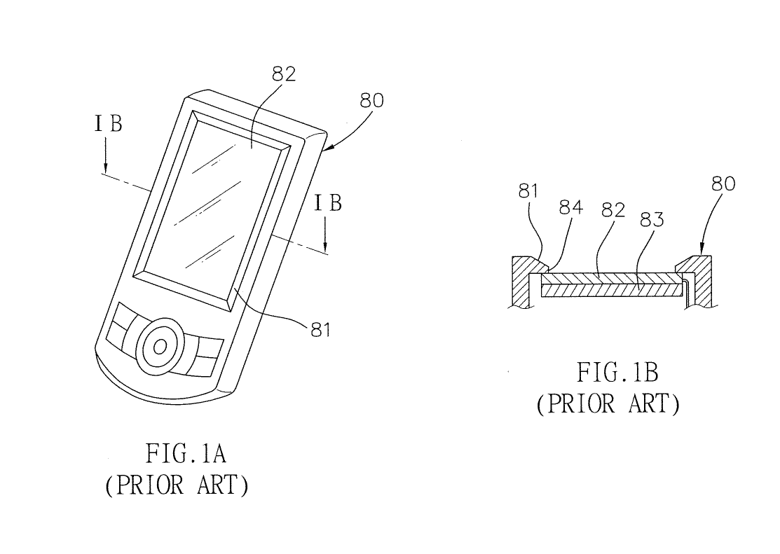

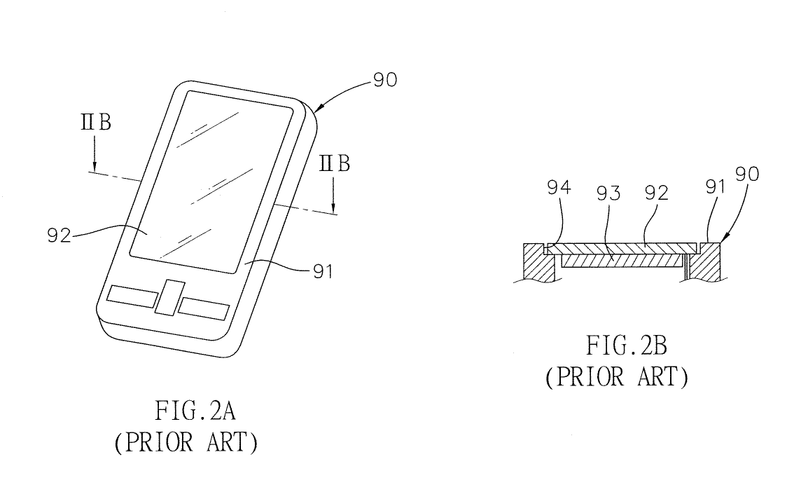

### LIST OF REFERENCE NUMBERS

110 film
112 decorated area
114 non-decorated area
120 shell
121 hollow area
130 touch panel
140 screen displaying portion
150 hard-coat layer
200 exterior seamless structure
300 internal structure
51 binding step
511 coating step
52 placing step
53 combing step
80 first traditional mobile phone
81 recessed casing
82 first touch panel
83 first screen displaying portion
84 recessed portion
90 second traditional mobile phone
91 casing
92 second touch panel
93 second screen displaying portion
94 seam
S1 flat surface
S2 smoothly-curved surface
S3 end surface

### DETAILED DESCRIPTION OF THE PREFERRED EMBODIMENT

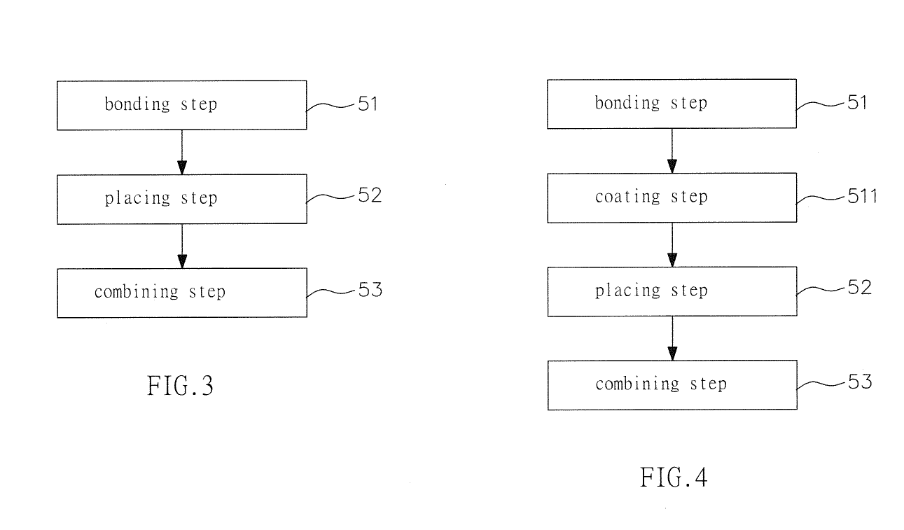

Referring to FIG. 3, the present invention relates to a method for manufacturing a touch panel having a seamless outer surface. It comprises the following steps:

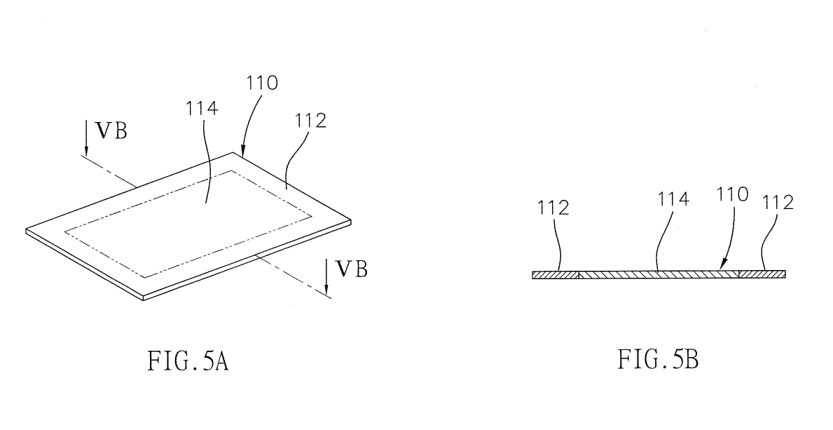

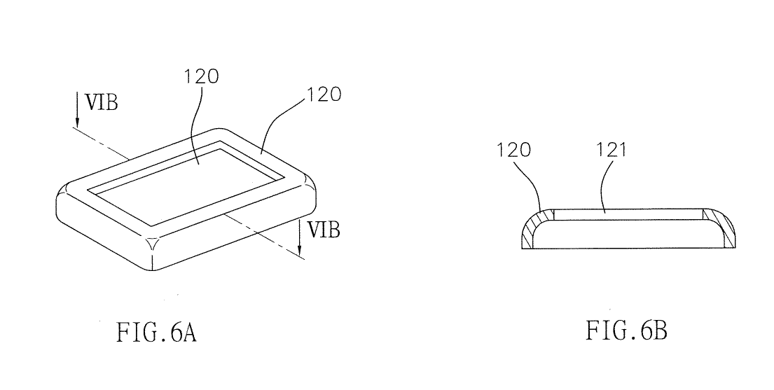

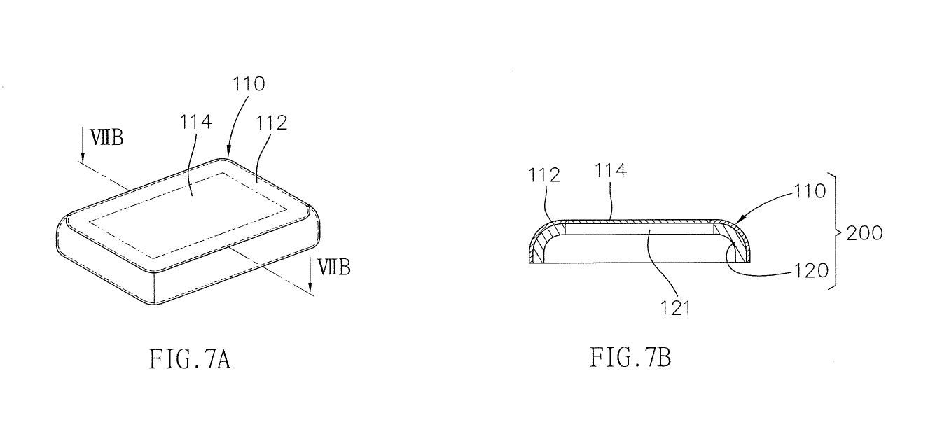

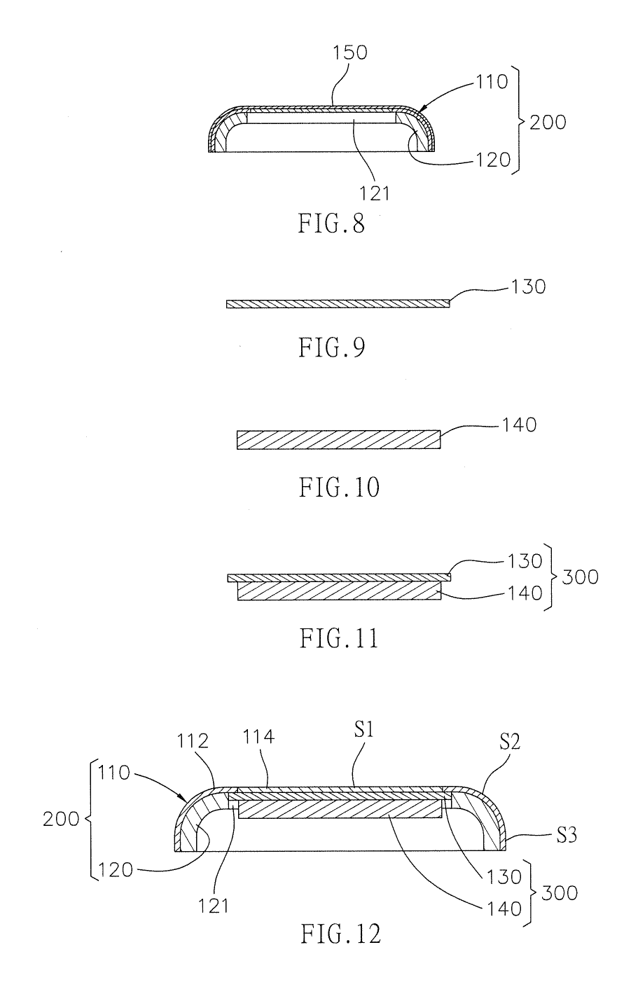

bonding step 51: as shown in FIGS. 5A, 5B, 6A and 6B, providing a film 110 having a seamless outer surface and a shell 120 having a hollow area 121, the film 110 having a decorated area 112 and a non-decorated area 114, the non-decorated area 114 and the hollow area 121 of the shell 120 being substantially overlapped for screen displaying; then bonding the film 110 onto an outer surface of the shell 120 so as to form an exterior seamless structure 200, as illustrated in FIGS. 7A and 7B;

placing step 52: as shown in FIGS. 9 and 10, providing a touch panel 130 and a screen displaying portion 140, placing the touch panel 130 and the screen displaying portion 140 together so as to form an internal structure 300, as exhibited in FIG. 11; the touch panel 130 being transparent; and

combing step 53: as illustrated in FIG. 12, placing the internal structure 300 into the hollow area 121 of the exterior seamless structure 200 with glue for expelling any air clearance so that the exterior seamless structure 200 and the internal structure 300 being combined as a final product which is an integral structure; the glue being transparent.

Of course, the decorated area 112 is possible to be omitted.

Usually, the screen displaying portion 140 can be a Liquid Crystal Module (LCM) or any other image generating element or device. Besides, the touch panel 130 is preferably a capacitive touch panel.

In addition, during the first forming step 51, the film 110 is made by a transparent plastic material which has a thickness preferably between 0.2 mm and 0.8 mm. The shell 120 is made by a plastic material, a metal material, a composite material, or a combination thereof. For example, the metal material could be aluminum, stainless steel, Al—Mg alloy or the like.

About the plastic material, it can be selected from polycarbonate (PC), polymethylmethacrylate (PMMA), polyethylene terephthalate (PET) material or the like.

The glue is preferably an optical liquid adhesive and having a transmittance greater than 85%.

Referring to FIG. 12, based on the above-mentioned manufacturing method, the final product can be obtained. It has a flat central surface S1, a smoothly-curved surface S2, and an end surface S3. The end surface S3 is substantially perpendicular to the flat surface S1, and the smoothly-curved surface S2 is smoothly and seamlessly connected with the flat central surface S1 and the end surface S2. Under such circumstances, the final product (such as a mobile phone) has a smooth and seamless outer surface, not only the aesthetic level is raised but also the touching feeling for holding or operating can be enhanced.

However, there is another embodiment of this invention, as illustrated in FIG. 4 and FIG. 9. It can further comprise the following step:

coating step 511: after the first forming step 51, forming a hard-coat layer 150 by coating transparent ultraviolet (UV) glue on the surface of the film 110 and then hardening the transparent UV glue by applying suitable UV light, so that a hard-coat layer 150 can be formed.

Furthermore, the hard-coat layer 150 preferably has a thickness within 50 μm (micrometers), and the hard-coat layer has a hardness greater than 3 (Mohs Hardness Scale). Under this condition, it has a better protective effect.

As shown in FIG. 12, the touch panel having a seamless outer surface mainly comprises an exterior seamless structure 200 and an internal structure 300.

About this exterior seamless structure 200, it has a film 110 having a seamless outer surface and a shell 120 having a hollow area 121. The film 110 has a decorated area 112 and a non-decorated area 114. The non-decorated area 114 and the hollow area 121 of the shell 120 are substantially overlapped for screen displaying.

Concerning the internal structure 300, it having a touch panel 130 and a screen displaying portion 140; the touch panel 130 being transparent; the exterior seamless structure 200 and the internal structure 300 being combined together so as to form as a final product which is an integral structure.

Of course, the decorated area 112 is possible to be omitted.

About the thickness of this film 110, the film 110 is made by a plastic material as well as the possible material of such plastic material can be referred in the previous description about the method. Similarly, the detailed description for the final product and the hard-coat layer (and its property, thickness and hardness) can be referred in the previous paragraphs, too.

With regard to the advantages and functions of the present invention, it can be summarized as follows:

1. Smooth surface.

2. Less shrinkage.

3. Good for decoration.

4. Ultra-thin shell. Please note that it can reduce 50% thickness of the shell than the one of the traditional shell. So, the shell of the present invention has better touch sensitive rate.

5. PET/PC/PMMA film possible.

6. Liquid Crystal Module (LCM) assembly possible.

7. Light transmittance at hollow area is larger than 85%.

8. The sensitivity of the touch panel will perform a better response than the traditional touch panel.

While this invention has been particularly shown and described with references to the preferred embodiments thereof, it will be understood by those skilled in the art that various changes or modifications can be made therein without departing from the scope of the invention by the appended claims.

What is claimed is:

1. A method for manufacturing a touch panel having a seamless outer surface:
binding step: providing a film having a seamless outer surface and a shell having a hollow area, said film having at least a non-decorated area, said non-decorated area and said hollow area of the shell being substantially overlapped for screen displaying; then bonding said film onto an outer surface of said shell so as to form an exterior seamless structure;
placing step: providing a touch panel and a screen displaying portion, placing said touch panel and said screen displaying portion together so as to form an internal structure; said touch panel being transparent; and
combining step: placing said internal structure into said hollow area of said exterior seamless structure with glue for expelling any air clearance so that said exterior seamless structure and said internal structure being combined as a final product which is an integral structure; said glue being transparent.

2. The method as defined in claim 1, wherein said film further has a decorated area.

3. The method as defined in claim 1, during said bonding step, wherein said film is made by a transparent plastic material which has a thickness between 0.2 mm and 0.8 mm; said shell is made by a material selected from a group consisting of a plastic material, a metal material, a composite material, and a combination thereof.

4. The method as defined in claim 3, wherein said plastic material is selected from a group consisting of polycarbonate (PC), polymethylmethacrylate (PMMA), polyethylene terephthalate (PET) material.

5. The method as defined in claim 1, said glue being an optical liquid adhesive, and said glue having a transmittance greater than 85%.

6. The method as defined in claim 1, said screen displaying portion being a Liquid Crystal Module (LCM); and said touch panel is a capacitive touch panel.

7. The method as defined in claim 1, wherein said final product has a flat central surface, a smoothly-curved surface, and an end surface, said end surface being substantially perpendicular to said flat surface, and said smoothly-curved surface being smoothly and seamlessly connected with said flat central surface and said end surface.

8. The method as defined in claim 1, further comprising:
coating step: after said bonding step, forming a hard-coat layer by coating transparent ultraviolet (UV) glue on said surface of the film and then hardening said transparent UV glue by applying suitable UV light, so that said hard-coat layer being formed.

9. The method as defined in claim 7, wherein said hard-coat layer has a thickness within 50 μm, and said hard-coat layer has a hardness greater than 3 (Mohs Hardness Scale).

10. A touch panel having a seamless outer surface comprising:
an exterior seamless structure having a film having a seamless outer surface and a shell having a hollow area, said film having at least a non-decorated area, said non-decorated area and said hollow area of the shell being substantially overlapped for screen displaying; and
an internal structure having a touch panel and a screen displaying portion; said touch panel being transparent; said exterior seamless structure and said internal structure being combined together so as to form as a final product which is an integral structure.

11. The method as defined in claim 10, wherein said film further has a decorated area.

12. The touch panel having a seamless outer surface as defined in claim 10, wherein said film is made by a transparent plastic material which has a thickness between 0.2 mm and 0.8 mm; said shell is made by a material selected from a group consisting of a plastic material, a metal material, a composite material, and a combination thereof.

13. The touch panel having a seamless outer surface as defined in claim 12, wherein said plastic material is selected from a group consisting of polycarbonate (PC), polymethylmethacrylate (PMMA), polyethylene terephthalate (PET) material.

14. The touch panel having a seamless outer surface as defined in claim 10, said screen displaying portion being a Liquid Crystal Module (LCM); and said touch panel is a capacitive touch panel.

15. The touch panel having a seamless outer surface as defined in claim 10, wherein said final product has a flat central surface, a smoothly-curved surface, and an end surface, said end surface being substantially perpendicular to said flat surface, and said smoothly-curved surface being smoothly and seamlessly connected with said flat central surface and said end surface.

16. The touch panel having a seamless outer surface as defined in claim 10, further comprising a hard-coat layer which is transparent and is coated on said film.

17. The touch panel having a seamless outer surface as defined in claim 10, wherein said hard-coat layer has a thickness within 50 μm, and said hard-coat layer has a hardness greater than 3 (Mohs Hardness Scale).
